(19) United States
(12) Patent Application Publication
(10) Pub. No.: US 2012/0154733 A1
(43) Pub. Date: Jun. 21, 2012

(54) DISPLAY PANEL

(75) Inventors: Yukinori Nakagawa, Osaka (JP); Isao Asako, Osaka (JP); Hiromi Nishino, Osaka (JP); Shinji Shimada, Osaka (JP)

(73) Assignee: SHARP KABUSHIKI KAISHA, Osaka (JP)

(21) Appl. No.: 13/393,136

(22) PCT Filed: May 21, 2010
(86) PCT No.: PCT/JP2010/058588

§ 371 Date: Feb. 28, 2012

(30) Foreign Application Priority Data
Sep. 1, 2009 (JP) 2009-201181

(51) Int. Cl. G02F 1/1339

(52) U.S. Cl. 349/153

(57) ABSTRACT

Provided is a liquid crystal display panel that employs polymer network liquid crystals and that can prevent a separation between a substrate and a liquid crystal layer. The liquid crystal display panel includes a color filter 1 and a TFT array substrate 2 that face each other in a substantially parallel manner with a prescribed gap therebetween, a layer of polymer network liquid crystals 33 formed between the color filter 1 and the TFT array substrate 2, and a layer of a sealing material 34 that encloses and seals the polymer network liquid crystals 33. In a region enclosed by the sealing material 34 in the color filter 1, first spacers 12a that define the gap between the color filter 1 and the TFT array substrate 2 are formed. A total cross-sectional area of the first spacers 12a and an area of the region enclosed by the sealing material 34 satisfy the following condition: (the total cross-sectional area of the first spacers 12a)/(the area of the region enclosed by the sealing material 34)=0.001 to 0.017.

### TECHNICAL FIELD

The present invention relates to a display panel, and more particularly, to a liquid crystal display panel that uses polymer network liquid crystals.

### BACKGROUND ART

Polymer network liquid crystals (PNLC) are liquid crystals that therein have polymer fiber structures (polymer microphase-separated structures; so-called polymer network). When no voltage is applied, the liquid molecules in the polymer network liquid crystals are randomly orientated along the polymer fibers, causing refraction index of the liquid crystals to differ from refraction index of the polymers, and therefore, light is scattered. This results in an opaque appearance of the polymer network liquid crystals. On the other hand, when a voltage is applied, the liquid molecules are aligned. Because the refraction index of the liquid crystals and the refraction index of the polymers are matched at this time, the scattering of light can be suppressed and the liquid crystals become transparent.

Various liquid crystal display panels that employ the polymer network liquid crystals (hereinafter may also be referred to as “PNLC display panels”) have been proposed. In addition to an application to reflective display panels (such as electronic papers, for example), the PNLC display panels can also be used for transmissive liquid crystal display panels as described in Patent Document 1, for example.

Generally, a transmissive liquid crystal display panel is equipped with two display panel substrates. An active matrix type liquid crystal display panel, for example, is equipped with a TFT array substrate and a color filter as display panel substrates, and is configured such that these two display panel substrates are bonded so as to face each other in a substantially parallel manner with a prescribed very small gap therebetween, and the gap is filled with liquid crystals (a liquid crystal layer is formed between the two display panel substrates).

In a conventional transmissive liquid crystal display panel, in order to display images properly, it is necessary to maintain a prescribed thickness of the liquid crystal layer (a gap between the two display panel substrates; a so-called cell gap) uniformly across the entire surface of the liquid crystal display panel. For this reason, some of liquid crystal display panels are configured such that a spacer, which is a protruding structure, is formed in one of the two display panel substrates, and the thickness of the liquid crystal layer is maintained constant by the spacer.

As described in Patent Document 2, such a configuration may be employed in a PNLC display panel. However, when the PNLC display panel is configured in a manner described above, the following problem may arise.

The polymer network liquid crystals filled in the PNLC display panel may shrink and reduce its volume during or after the manufacturing process of the PNLC display panel. When the PNLC display panel is placed in a low-temperature environment, for example, the polymer network liquid crystals reduce its volume with decrease in temperature. Also, in forming the polymer network liquid crystals, a liquid crystal material including monomers is irradiated with light energy such as ultraviolet light so that the monomers are polymerized, and polymer microphase-separated structures are therefore formed inside of the liquid crystal material. During the polymerization, the volume of polymers may be reduced, and as a result, the volume of the polymer network liquid crystals may be reduced.

When the volume of the polymer network liquid crystals filled between the two display panel substrates is reduced, the two display panel substrates tend to deform inwards so as to follow the volume reduction of the polymer network liquid crystals. This makes the gap between the two display panel substrates narrower. However, if a spacer is formed between the two display panel substrates, the spacer keeps the two display panel substrates from deforming and getting closer to each other. Therefore, the two display panel substrates cannot be deformed so as to follow the volume reduction of the liquid crystals. This causes the polymer network liquid crystals to separate from the display panel substrate at the interface between the polymer network liquid crystals and the display panel substrate, resulting in an air bubble generated in a location where the separation has occurred. The generated air bubble may cause display non-uniformity in an image displayed by the PNLC display panel, and as a result, the display quality may be lowered. FIG. 13 is a plan view that schematically shows an example of the display non-uniformity caused by the presence of the air bubble. Each of the regions defined by a black grid 71 shown in FIG. 13 schematically shows one pixel. As shown in FIG. 13, the air bubbles 72 may spread over several pixels to hundreds of pixels due to an accumulated internal stress. In this case, the air bubbles cause display non-uniformity, which is recognized as a serious problem.

### RELATED ART DOCUMENTS

### Patent Documents

Patent Document 1: Japanese Patent Application Laid-Open Publication No. 2009-025354
Patent Document 2: Japanese Patent Application Laid-Open Publication No. 2006-330024

### SUMMARY OF THE INVENTION

### Problems to be Solved by the Invention

In consideration of the situation described above, the present invention is aiming at providing a liquid crystal display panel that uses polymer network liquid crystals and that can prevent or suppress a separation of the polymer network liquid crystals from a display panel substrate at the interface between the polymer network liquid crystals and the display panel substrate, or providing a display panel that uses polymer network liquid crystals and that can prevent or suppress the occurrence of display non-uniformity caused by the polymer network liquid crystals being separated from the display panel substrate, and display non-uniformity caused by a change in the thickness of the liquid crystal layer.

### Means for Solving the Problems

In order to solve the above-mentioned problem, a display panel of the present invention includes:

two substrates that face each other in a substantially parallel manner with a prescribed gap therebetween;

a layer of a liquid crystal formed between the two substrates; and

a layer of a sealing material that encloses and seals the liquid crystal,

wherein the liquid crystal layer is a layer made of a polymer network liquid crystal,

wherein at least one of the two substrates has first spacers that define the gap between the two substrates in a region enclosed by the sealing material, and

wherein a total cross-sectional area of the first spacers and an area of the region enclosed by the sealing material are set so as to satisfy the following condition: (the total cross-sectional area of the first spacers)/(the area of the region enclosed by the sealing material)=0.001 to 0.017.

Here, “a cross-sectional area of the first spacer” refers to an area of the cross-section that appears when each first spacer is cut along a plane parallel to the plane direction of the display panel substrate.

A columnar structure may be used as the first spacer.

A color filter including a colored layer may be used as one of the two substrates. A TFT array substrate including a pixel electrode and a thin film transistor that drives the pixel electrode may be used as the other of the two substrates. The first spacer can be configured so as to be formed in the color filter.

One of the two substrates can be configured to include a second spacer that is shorter than the first spacer. It is preferable that a height difference between the first spacer and the second spacer be in a range of 0.1 to 1.0 μm.

The second spacer can be configured so as to be formed in the color filter.

In a configuration where the first spacer and the second spacer are formed in the color filter, the first spacer and the second spacer can be configured so as to be made of the same material.

### Effects of the Invention

According to the present invention, even when the volume of the polymer network liquid crystals is changed, because the first spacer is deformed, the display panel substrate can be deformed so as to follow the volume change of the polymer network liquid crystals. This can prevent or suppress the separation of the polymer network liquid crystals from a surface of the display panel substrate at the interface between the polymer network liquid crystals and the display panel substrate. Also, by the first spacer, the gap between the two display panel substrates (thickness of the polymer network liquid crystal layer; a so-called cell gap) can be maintained at a prescribed value.

When a value derived from (the total cross-sectional area of the first spacers)/(the area of the region enclosed by the sealing material) exceeds 0.017, the separation of the liquid crystal cannot be prevented, and when the value is smaller than 0.001, the cell gap cannot be maintained at a prescribed value by the first spacer.

Also, according to the present invention, because the separation of the polymer network liquid crystals can be prevented or suppressed, the occurrence of air bubbles at the interface between the polymer network liquid crystals and the display panel substrate can be prevented or suppressed. Further, the cell gap can be maintained at a prescribed value. Therefore, not only the occurrence of display non-uniformity caused by the presence of air bubbles can be prevented or suppressed, but also the occurrence of display non-uniformity caused by a change in the cell gap (uneven cell gap, for example) can be prevented or suppressed. This allows the display panel according to the present invention to perform a high-quality display (or a deterioration of display quality of the display panel can be prevented according to the present invention).

When the display panel is configured to include the second spacer that is shorter than the first spacer, when a strong pressure load is applied to the display panel, the second spacer, in addition to the first spacer, fulfills a function of maintaining the cell gap at a prescribed value.

That is, when no or only a small pressure load is applied to the display panel from the outside, an end of the second spacer does not make contact with a surface of the display panel substrate, and therefore, the cell gap is defined by the first spacer only. Thus, in this condition, by the first spacer being deformed, the display panel substrate is allowed to deform so as to follow the volume change of the polymer network liquid crystals, and therefore, the separation of the polymer network liquid crystals is prevented or suppressed.

When a strong pressure load is applied to the display panel from the outside, the first spacer is compressively deformed, and is reduced in height. As a result, the end of the second spacer makes contact with the surface of the display panel substrate. This makes the second spacer, in addition to the first spacer, fulfill a function of maintaining the cell gap at a prescribed value. That is, in this condition, the cell gap is maintained at prescribed values by the first spacer and the second spacer.

As described above, according to the display panel of the present invention, when the volume of the polymer network liquid crystals is changed, the display panel substrate is allowed to deform so as to follow the volume change of the polymer network liquid crystals, and therefore, the separation of the polymer network liquid crystals is prevented or suppressed. On the other hand, when a strong pressure load is applied to the display panel, the deformation of the display panel substrate can be prevented or suppressed so that the cell gap is maintained at a prescribed value.

### BRIEF DESCRIPTION OF THE DRAWINGS

FIG. 1 is an exterior perspective view schematically showing a configuration of a display panel according to an embodiment of the present invention.

FIG. 2 is a cross-sectional view along the line A-A in FIG. 1 that schematically shows a cross-sectional configuration of a display panel according to an embodiment of the present invention.

FIG. 3 is an enlarged cross-sectional view of a selected portion of FIG. 2 that schematically shows a cross-sectional configuration of a display panel according to an embodiment of the present invention.

FIG. 4 is an exterior perspective view that schematically shows a configuration of a first substrate.

FIG. 5 shows diagrams that schematically illustrate a configuration of pixels formed on a first substrate. FIG. 5(a) is a plan view showing a planar configuration of pixels. FIG. 5(b) is a cross-sectional view along the line A-A in FIG. 5(a) that schematically shows a cross-sectional configuration of pixels.

FIG. 6 is an exterior perspective view that schematically shows a configuration of a second substrate of a display panel according to an embodiment of the present invention.

FIG. 7 is a plan view that schematically shows a configuration of pixels formed in a second substrate of a display panel according to an embodiment of the present invention.

FIG. 8 is a cross-sectional view that schematically shows a cross-sectional configuration of pixels formed in a second substrate of a display panel according to an embodiment of the present invention.

FIG. 9 is a cross-sectional view that schematically shows prescribed processes of a manufacturing process of a color filter. The figure is a cross-sectional view that schematically shows processes of forming a black matrix to forming a common electrode.

FIG. 10 is a cross-sectional view that schematically shows a prescribed step of a manufacturing process of a color filter. The figure is a cross-sectional view that schematically shows a step of forming a film of a photosensitive resin composite in a process of forming a spacer.

FIG. 11 is a cross-sectional view that schematically shows a prescribed step of a manufacturing process of a color filter. The figure is a cross-sectional view that schematically shows an exposure step in a process of forming a spacer.

FIG. 12 is a cross-sectional view that schematically shows a prescribed step in a manufacturing process of a color filter. The figure is a cross-sectional view that schematically shows a development step in a process of forming a spacer.

FIG. 13 is a plan view that schematically shows display non-uniformity caused by air bubbles.

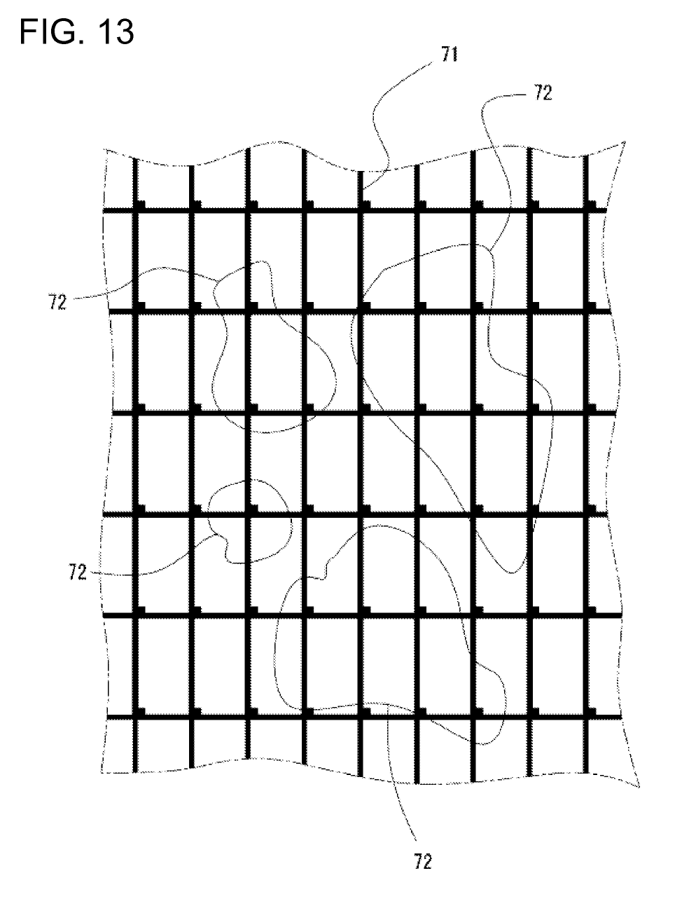

### DETAILED DESCRIPTION OF EMBODIMENTS

Embodiments of the present invention will be explained in detail below with reference to figures. A display panel according to the embodiments of the present invention is an active matrix type liquid crystal display panel that employs PNLCs (Polymer Network Liquid Crystals).

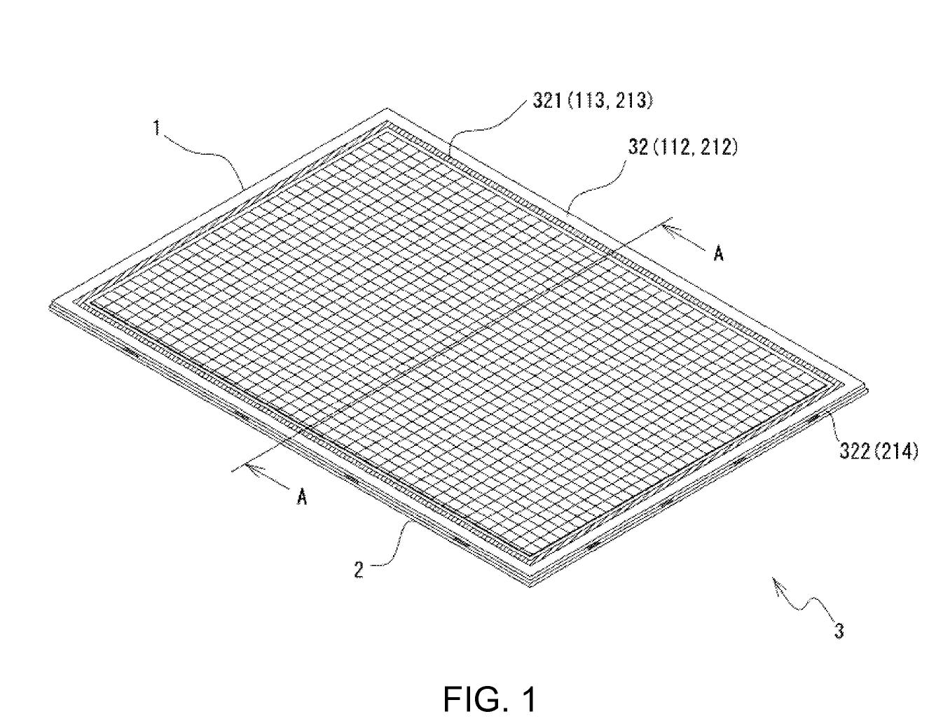

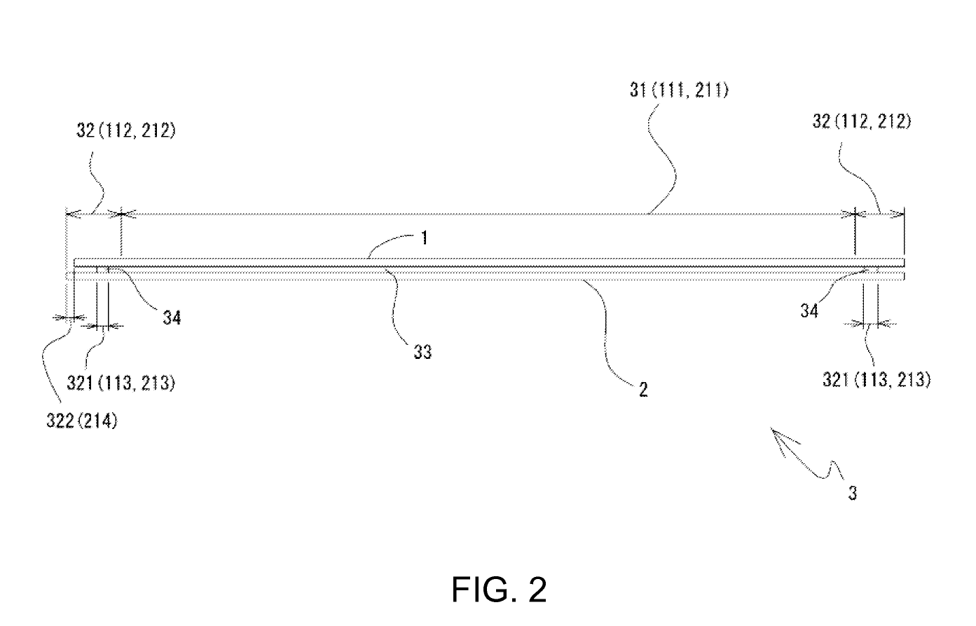

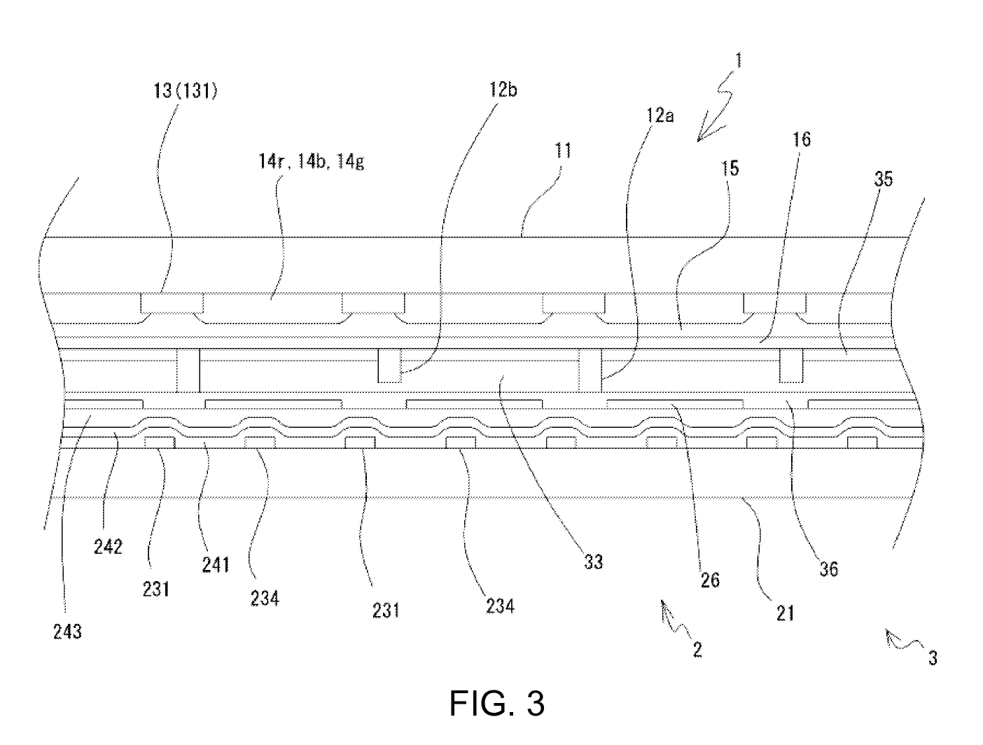

First, an overall configuration of a display panel 3 according to an embodiment of the present invention will be explained. FIG. 1 is an exterior perspective view schematically showing a configuration of the display panel 3 according to the embodiment of the present invention. FIG. 2 is a cross-sectional view along the line A-A in FIG. 1 that schematically shows a cross-sectional configuration of the display panel 3 according to the embodiment of the present invention. FIG. 3 is a partial enlarged view that shows a selected portion of FIG. 2, and is a cross-sectional view that schematically shows a cross-sectional structure of the display panel 3 according to the embodiment of the present invention.

As shown in FIGS. 1 to 3, respectively, the display panel 3 according to the embodiment of the present invention includes two display panel substrates, which are a first substrate 1 and a second substrate 2. The first substrate 1 of the display panel 3 of the present embodiment is a color filter. The second substrate 2 of the display panel 3 of the present embodiment is a TFT array substrate. The display panel 3 of the present embodiment has a configuration where the first substrate 1 and the second substrate 2 are bonded to face each other in a substantially parallel manner having a prescribed very small gap therebetween. Further, between the two substrates, a layer of polymer network liquid crystals 33 is formed, and the layer of the polymer network liquid crystals 33 is sealed by a layer of a sealing material 34. On respective surfaces of the first substrate 1 and the second substrate 2, prescribed elements (will be later described in detail) are formed, but they are not shown in FIG. 2.

In the display panel 3 (the first substrate 1 and the second substrate 2) of the present embodiment, a display region 31 (may also be referred to as “pixel region” or the like) and a panel frame region 32 are formed. The display region 31 is a region where images are displayed. In the display region 31, pixels are arranged in a prescribed manner. The panel frame region 32 is formed outside of the display region 31 so as to enclose the display region 31. In the panel frame region 32, a sealing pattern region 321 (a region indicated with the hatching in FIG. 1), a terminal region 322, and prescribed wiring lines and the like are formed.

In the sealing pattern region 321, a layer of the sealing material 34 is formed. The sealing pattern region 321 is a band-shaped region that is formed so as to enclose the display region 31 with no opening. As shown in FIG. 2 in particular, in the sealing pattern region 321, the layer of the sealing material 34 is formed between the first substrate 1 and the second substrate 2. The first substrate 1 and the second substrate 2 are bonded to each other by the layer of sealing material 34, and a region enclosed by the layer of the sealing material 34 is filled with the polymer network liquid crystals 33 (that is, the polymer network liquid crystals 33 are sealed by the layer of the sealing material 34). In this way, the layer of the polymer network liquid crystals 33 is formed between the first substrate 1 and the second substrate 2 in the display region 31 of the display panel 3 according to the embodiment of the present invention.

The polymer network liquid crystals 33 are liquid crystals having a polymer microphase-separated structure (polymer network). The polymer network liquid crystals 33 can be obtained by radiating ultraviolet light to a liquid crystal material including monomers (acrylic monomers, for example) so that the monomers are polymerized and a microphase-separated structure of polymers is formed therein, for example. Various known polymer network liquid crystals can be used as the polymer network liquid crystals 33 of the display panel 3 as embodiments of the present invention, and therefore, the explanation thereof will be omitted.

On one surface of the first substrate 1 (a surface of the side facing the second substrate 2), first spacers 12a and second spacers 12b, which are columnar structures (in other words, protruding structures), are formed. The first spacers 12a and the second spacers 12b are structures that respectively define thicknesses (maintain at prescribed dimensions) of the layer of the polymer network liquid crystals 33 (in other words, the height of the gap formed between the first substrate 1 and the second substrate 2, referred to as “cell gap” hereinafter) of the display panel 3 of the embodiment of the present invention.

The height of the first spacers 12a (protrusion length from a surface of a common electrode 16 (will be later described)) is determined based on the cell gap of the display panel 3 according to the embodiment of the present invention. The height of the second spacers 12b is also determined based on the cell gap of the display panel 3 according to the embodiment of the present invention. Table 1 shows a relationship of a difference in height between the first spacers 12a and the second spacers 12b with the occurrence of display non-uniformity, and with the function of maintaining the cell gap. The height of the second spacers 12b is set to be smaller than the height of the first spacers 12a. However, as shown in Table 1, when the difference in height between the first spacers 12a and the second spacers 12b becomes smaller than 0.1 μm, the separation of the liquid crystal cannot be prevented. If the difference exceeds 1.0 μm, the cell gap cannot be maintained at a prescribed value when a strong pressure load from the outside is applied to the display panel 3 in the embodiment of the present invention. Therefore, the difference in height between the first spacers 12a and the second spacers 12b is set to be in a range of 0.1 μm to 1.0 μm.

TABLE 1
Relationship of Height Difference between First
Spacer and Second Spacer with Occurrence of Display
Non-Uniformity and with Function of Maintaining Cell Gap

| Height difference | Evaluation on | Cell gap upon | |
|---|---|---|---|
| between first spacer | display non- | application of | |
| and second pacer | uniformity | pressure load | Evaluation |
| 0.05 | NG | OK | NG |
| 0.1 | OK | OK | OK |
| 0.5 | OK | OK | OK |
| 1 | OK | OK | OK |
| 1.5 | OK | NG | NG |
| 2 | OK | NG | NG |

Therefore, when no or little pressure load from the outside (particularly, a pressure load that makes the gap between the first substrate 1 and the second substrate 2 smaller; a compressive force, for example) is applied to the display panel 3 of the embodiment of the present invention, as shown in the respective FIGS. 2 and 3 in particular, the ends of the first spacers 12a are in contact with the surface of the second substrate 2 (more accurately, a structure that is formed in the uppermost layer of prescribed structures formed in the second substrate 2; an alignment film in the display panel 3 in the present embodiment). However, the ends of the second spacers 12b are not in contact with the surface of the second substrate 2, and between the ends of the second spacers 12b and the second substrate 2, a gap of a prescribed dimension is formed in accordance with a difference in height between the first spacers 12a and the second spacers 12b.

There is no special limitation on the number of the first spacers 12a, but a cross-sectional area (here, referred to an area of a cross-section that appears when the spacer is cut in a direction parallel to the surface of the first substrate 1) of each first spacer 12a and the number of the first spacers 12a are set so as to satisfy the following condition. That is, they are set so as to satisfy: (the total cross-sectional areas of the first spacers 12a)/(an area of the region enclosed by the layer of the sealing material 34)=0.001 to 0.017.

There is no special limitation on the number of the second spacers 12b or a cross-sectional area of each second spacer 12b; there is no need to satisfy conditions similar to that for the first spacers 12a.

The first spacers 12a and the second spacers 12b are formed in prescribed locations such that they don't interfere with the image display of the display panel 3 of the present embodiment. The specific locations will be described below.

The terminal region 322 is formed at the outer edge or near the outer edge of prescribed side(s) of the panel frame region 32. The display panel 3 according to the embodiment of the present invention that is shown in FIGS. 1 to 3, respectively, is configured such that the terminal region 322 is formed at the respective outer edges of one of the longer sides and one of the shorter sides. In the terminal region 322, terminals (referred to as “wiring electrode terminals”) for various prescribed wiring lines that are formed in the display panel 3 according to the embodiment of the present invention are disposed for connecting a prescribed circuit board. In the display panel 3 of the embodiment of the present invention, the terminal region 322 is formed only in the second substrate 2, and is not formed in the first substrate 1. The prescribed wiring lines that are formed in the panel frame region 32 will be later described.

According to such a configuration, even when the volume of the polymer network liquid crystals 33 is changed (especially even when the volume is reduced), because the first spacers 12a are deformed, the first substrate 1 and the second substrate 2 are allowed to deform so as to follow the volume change of the polymer network liquid crystals 33. Therefore, at the interface(s) between the polymer network liquid crystals 33 and the first substrate 1 and/or the second substrate 2, the separation of the polymer network liquid crystals 33 from the surface(s) of the first substrate 1 and/or the second substrate 2 can be prevented or suppressed. Also, by the first spacers 12a, the cell gap can be maintained at a prescribed value.

Table 2 shows a relationship of a value derived from (the total cross-sectional areas of the first spacers 12a)/(the area of the region enclosed by the layer of sealing material 34) (this value is described as “density of first spacers” in Table 2) with the occurrence of display non-uniformity, and with the function of maintaining the cell gap. As shown in Table 2, when the value derived from (the total cross-sectional areas of the first spacers 12a)/(the area of the region enclosed by the layer of sealing material 34) exceeds 0.017, the separation of the liquid crystal cannot be prevented, and when the value is smaller than 0.001, the cell gap cannot be maintained at a prescribed value by the first spacers 12a.

TABLE 2
Relationship of Density of First Spacers with
Occurrence of Display Non-Uniformity
and with Function of Maintaining Cell Gap

| | Evaluation on | Cell gap upon | |
|---|---|---|---|
| Density of | display non- | application of | |
| first spacers | uniformity | pressure load | Evaluation |
| 0.032 | NG | OK | NG |
| 0.025 | NG | OK | NG |
| 0.020 | NG | OK | NG |
| 0.017 | OK | OK | OK |
| 0.012 | OK | OK | OK |
| 0.0050 | OK | OK | OK |
| 0.0010 | OK | OK | OK |
| 0.0005 | OK | NG | NG |

In the display panel 3 according to the embodiment of the present invention, because the separation of the polymer network liquid crystals 33 can be prevented or suppressed, the occurrence of an air bubble at the interface(s) between the polymer network liquid crystals 33 and the first substrate 1 and/or the second substrate 2 can be prevented or suppressed. Further, the cell gap can also be maintained at a prescribed value. Therefore, not only the occurrence of display non-uniformity caused by the presence of air bubbles, but also the occurrence of display non-uniformity caused by a change in the cell gap (uneven cell gap, for example) can be prevented or suppressed. This allows the display panel 3 according to the embodiment of the present invention to perform a high-quality display (or a deterioration of display quality can be prevented).

If the display panel is configured to have the second spacers 12b that are shorter than the first spacers 12a, the cell gap can be maintained at a prescribed value even when a strong pressure load (particularly, a pressure load that makes the first substrate 1 and the second substrate 2 of the display panel 3 of the present embodiment get closer; a compressive force) is applied to the display panel 3 of the present embodiment.

That is, with no or only a small pressure load from the outside applied to the display panel 3 of the present embodiment, the ends of the second spacers 12b are not in contact with the surface of the second substrate 2, and therefore, the cell gap is defined by the first spacers 12a only. Thus, in this condition, because the first spacers 12a are deformed, the first substrate 1 and the second substrate 2 are allowed to deform so as to follow the volume change of the polymer network liquid crystals 33. This can prevent or suppress the separation of the polymer network liquid crystals 33.

When a strong pressure load is applied from the outside to the display panel 3 of the present embodiment, the first spacers 12a are compressively deformed, and are reduced in height. As a result, the ends of the second spacers 12b make contact with the surface of the second substrate 3. Therefore, the second spacers 12b, in addition to the first spacers 12a, fulfill a function of maintaining the cell gap at a prescribed value. When the second spacers 12b, in addition to the first spacers 12a, fulfill a function of defining the cell gap, the display panel 3 of the embodiment of the present invention becomes stronger against the pressure load (becomes less likely to deform). Thus, even when a strong pressure load from the outside is applied to the display panel 3 of the present embodiment, the cell gap of the display panel 3 of the present embodiment is maintained at a prescribed value. That is, in this condition, the cell gap of the display panel 3 of the present embodiment is maintained at a prescribed value by the first spacers 12a and the second spacers 12b.

In particular, when the difference in height between the first spacers 12a and the second spacers 12b is set in a range of 0.1 to 1.0 μm, both the prevention or suppression of the separation of the polymer network liquid crystals 33 and the retention of the cell gap can be achieved more effectively.

As described above, in the display panel 3 according to the embodiment of the present invention, when the volume of the polymer network liquid crystals 33 is changed, the first substrate 1 and the second substrate 2 are allowed to deform so as to follow the volume change of the polymer network liquid crystals 33, thereby preventing or suppressing the separation of the polymer network liquid crystals 33. On the other hand, when a strong pressure load is applied, the deformation of the first substrate 1 and the second substrate 2 is prevented or suppressed, and therefore, the cell gap can be maintained at a prescribed value.

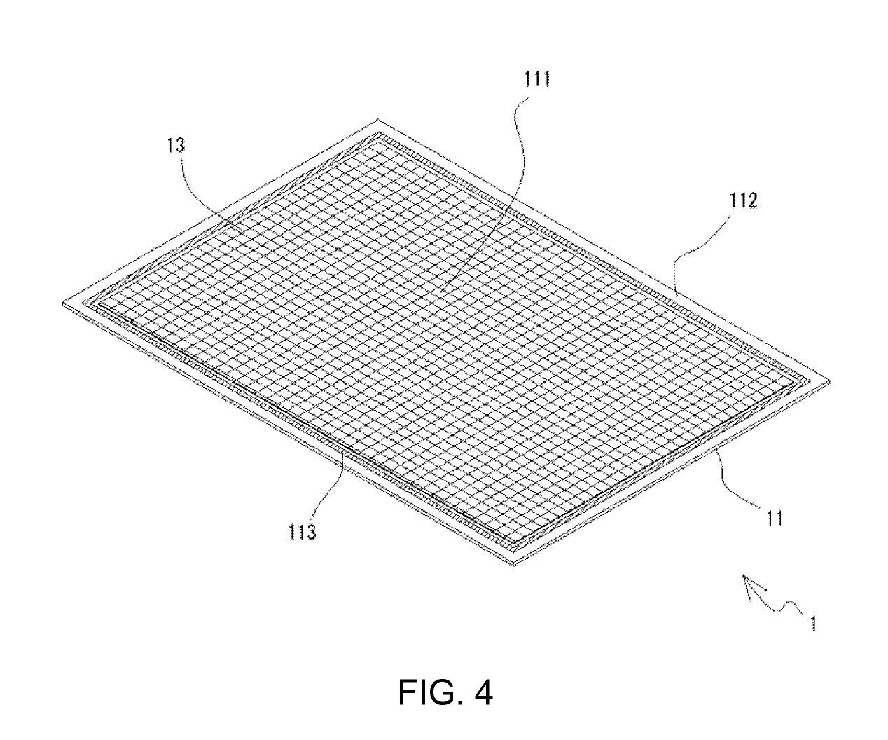

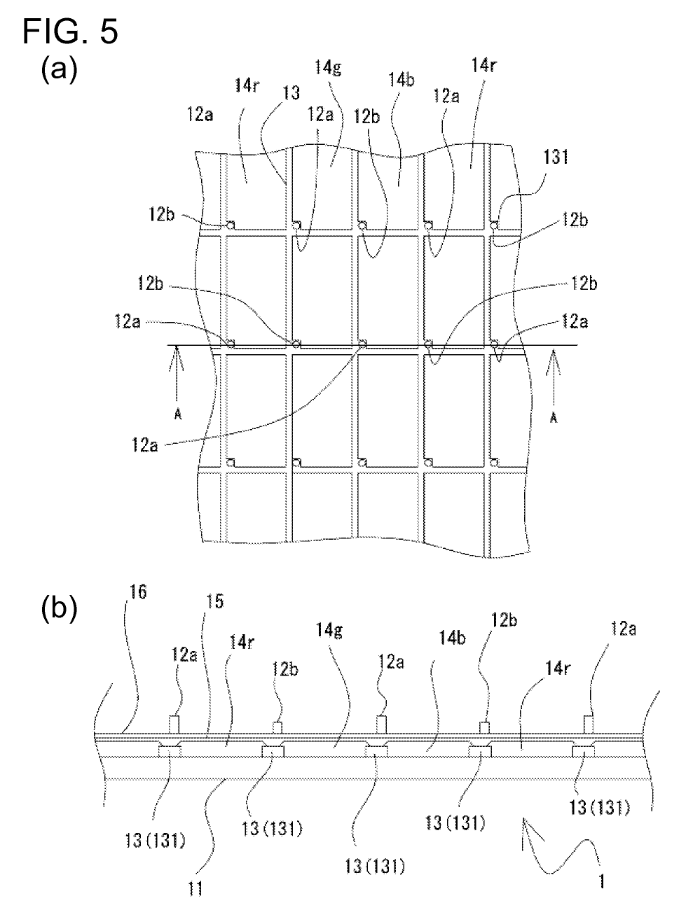

Next, the first substrate 1 will be explained. FIG. 4 is an exterior perspective view that schematically shows a configuration of the first substrate 1. FIG. 5 shows diagrams that schematically illustrate a configuration of pixels formed in the first substrate 1. Specifically, FIG. 5(a) is a plan view showing a planar structure of the pixels, and FIG. 5(b) is a cross-sectional view along the line A-A in FIG. 5(a) that schematically shows a cross-sectional structure of the pixels, respectively.

As shown in FIGS. 4, 5(a), and 5(b), the first substrate 1 is configured such that a display region 111 and a panel frame region 112 are formed on a surface of a transparent substrate 11 made of glass or the like.

In the display region 111, pixels are arranged in a prescribed manner. FIGS. 4, 5(a), and 5(b) show a configuration in which the pixels are arranged in a matrix (one of the so-called “stripe pattern,” “diagonal pattern,” and “rectangle pattern”), but there is no special limitation on the arrangement pattern of the pixels. The pixels may be arranged in a delta pattern, for example.

The panel frame region 112 is formed so as to enclose the display region 111. In the panel frame region 112, a sealing pattern region 113 is formed. The sealing pattern region 113 is a region where the layer of the sealing material 34 is formed, and has a prescribed width dimension (dimension in the direction perpendicular to the longitudinal direction of each side). The sealing pattern region 113 is formed so as to enclose the display region 111 with no opening.

As shown in FIGS. 4, 5(a), and 5(b), on one surface of the first substrate 1, a black matrix 13 is formed. The black matrix 13 is a film-shape structure that has a light-shielding property. The black matrix 13 is formed of a photosensitive resin composite (a photosensitive acrylic resin composite, for example) including a black colorant (a colorant having a light-shielding property), or a metal (chrome (Cr) or the like, for example), for example.

The black matrix 13 defines pixels in the display region 111. As shown in FIGS. 4, 5(a), and 5(b), in a portion of the black matrix 13 that is formed in the display region 111, openings of a prescribed shape are formed and arranged in a prescribed manner. The respective openings formed in the black matrix 13 become portions that transmit light in the respective pixels. As shown in FIGS. 4, 5(a), and 5(b), the openings are generally formed to be substantially rectangular.

In the openings formed in the black matrix 13 (that is, regions defined by the grid of the black matrix 13), colored layers in three colors, which are red colored layers 14r, green colored layers 14g, and blue colored layers 14b, are formed. There is no limitation on types and the number of colors of the colored layers. The colored layers may also be configured to have five colors in total that include cyan colored layers and yellow colored layers, for example, in addition to the colored layers in the three colors: the red colored layers 14r; green colored layers 14g; and blue colored layers 14b.

As shown in FIG. 5(b) in particular, on the surfaces of the black matrix 13 and the colored layers of the respective colors 14r, 14g, and 14b, a protective film 15 is formed. The protective film 15 is formed of an acrylic resin composite, an epoxy resin composite, or the like. On the surface of the protective film 15, a common electrode 16 is formed. The common electrode 16 is a film made of a transparent conductive material, and is formed of Indium Tin Oxide (ITO), for example.

The first spacers 12a and the second spacers 12b are formed on the surface of the common electrode 16 in locations that overlap prescribed portions of the black matrix 13. Specifically, as shown in FIG. 5(a) in particular, spacer forming regions 131 are formed in the black matrix 13. The spacer forming regions 131 are formed near respective intersections of the grids of the black matrix 13 so as to extend toward inside of the respective openings. In each of the locations that are on the surface of the common electrode 16 and that overlap the respective spacer forming regions 131, one of the first spacers 12a and the second spacers 12b is selectively disposed.

Because the first spacers 12a and the second spacers 12b are formed in the locations that overlap the black matrix 13, the first spacers 12a and the second spacers 12b do not interfere with the image display of the display panel 3 according to the embodiment of the present invention.

The first spacers 12a and the second spacers 12b are columnar structures (in other words, protruding structures). The first spacers 12a and the second spacers 12b are formed of a photosensitive resin composite.

The number of the first spacers 12a and the cross-sectional area of the respective first spacers 12a have been described earlier. Before the first substrate 1 and the second substrate 2 are bonded by the sealing material 34 (when the first substrate 1 exists as a single component), the number and the cross-sectional area can be represented as follows: (the total cross-sectional area of the first spacers 12a)/(the area of the region enclosed by the sealing pattern region 113)=0.0001 to 0.0017.

The first spacers 12a are structures that define the cell gap (maintain at a prescribed value) of the display panel 3 according to the embodiment of the present invention. Therefore, the height of the first spacers 12a is determined in accordance with a cell gap of the display panel 3 according to an embodiment of the present invention. That is, the height is set so that the cell gap has a prescribed dimension when the first substrate 1 and the second substrate 2 are bonded, and the ends of the first spacers 12a formed in the first substrate 1 make contact with the surface of the second substrate 2 (more accurately, a surface of a structure that is disposed in the uppermost layer of the prescribed structures formed in the second substrate 2; an alignment film in the display panel 3 of the present embodiment). Specifically, the height of the first spacers 12a (protrusion length from the common electrode 16) is set so as to be the substantially same as the dimension of the cell gap.

The second spacers 12b define the cell gap of the display panel 3 of the present embodiment together with the first spacers 12a. Therefore, the height of the second spacers 12b is also determined in accordance with a cell gap of the display panel 3 according to an embodiment of the present invention. The height of the second spacers 12b is set so as to be shorter than the height of the first spacers 12a by 0.1 to 1.0 μm.

In FIG. 5, the diagrams show a configuration in which the spacer forming regions 131 are formed at all intersections of the grids of the black matrix 13, and the first spacers 12a and the second spacers 12b are alternately formed in the locations that overlap the respective spacer forming regions 131. However, the spacer forming regions 131 may also be formed at some of the intersections of the grids of the black matrix 13, and the first spacers 12a and the second spacers 12b may also be alternately formed in the locations that overlap those spacer forming regions 131.

Next, the second substrate 2 of the display panel 3 according to the embodiment of the present invention will be explained. Various known TFT array substrates can be used as the second substrate 2 of the display panel 3 according to the present embodiment, and therefore, it will be only briefly explained.

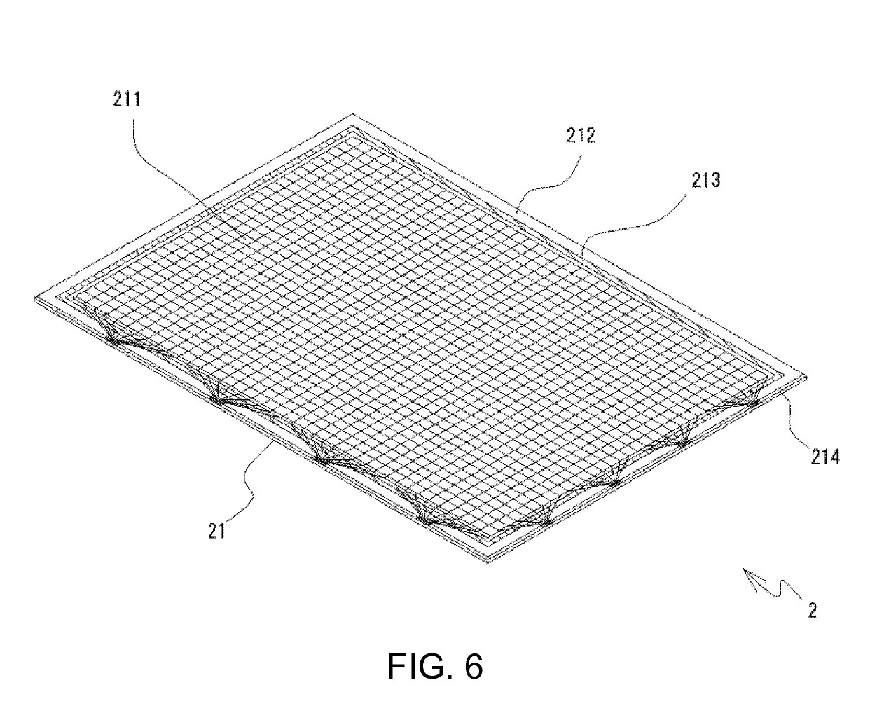

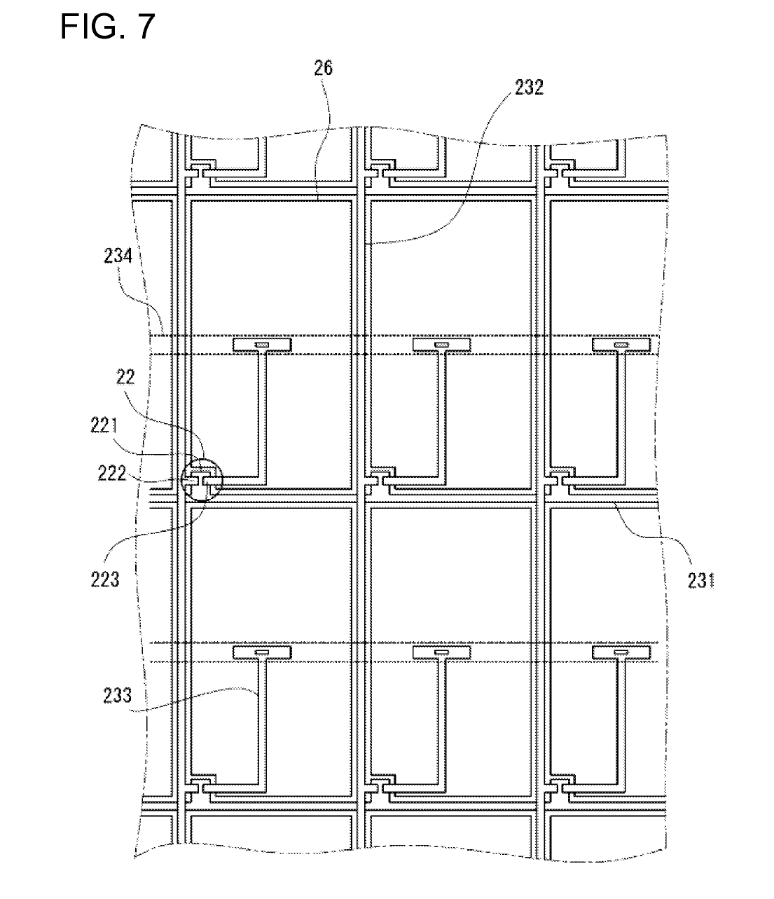

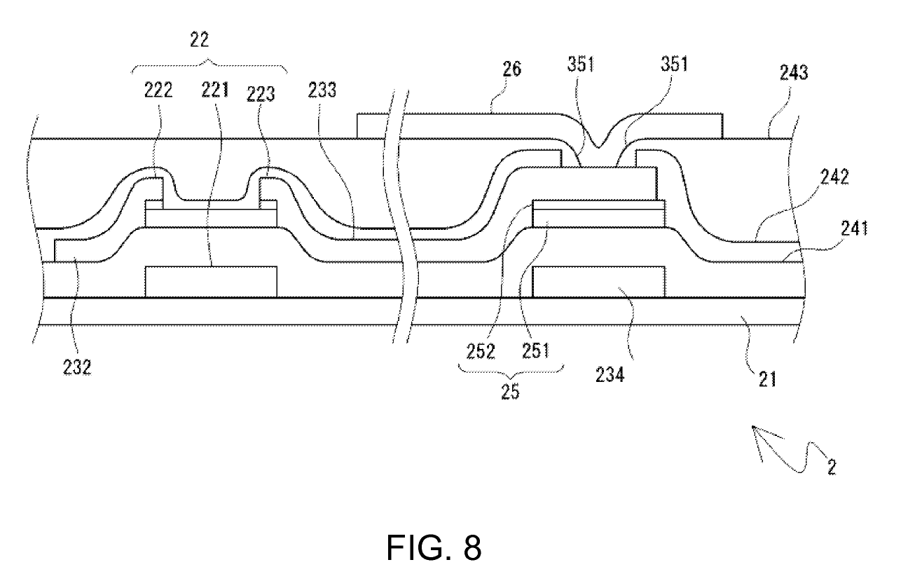

FIG. 6 is an exterior perspective view that schematically shows a configuration of the second substrate 2 of the display panel 3 according to the embodiment of the present invention. FIG. 7 is a plan view schematically showing a configuration of pixels formed in the second substrate 2 of the display panel 3 according to the embodiment of the present invention. FIG. 8 is a cross-sectional view that schematically shows a cross-sectional configuration of the pixels formed in the second substrate 2 of the display panel 3 according to the embodiment of the present invention. It should be noted that FIG. 8 is a schematic view for explaining a cross-sectional configuration of the pixels, and is not an actual cross-sectional view taken along a particular line.

As shown in FIGS. 6 to 8, respectively (as shown in FIG. 6 in particular), the second substrate 2 has a configuration in which a display region 211 and a panel frame region 212 are formed on the surface of a transparent substrate 21 made of glass or the like.

In the display region 211, a prescribed number of pixel electrodes 26 and thin film transistors (TFTs) 22 that are switching elements for driving the respective pixel electrodes 26 are arranged in a prescribed manner, respectively. An arrangement pattern of the pixel electrodes 26 and the thin film transistors 22 is the same as the arrangement pattern of the pixels of the first substrate 1. Further, in the display region 211, a prescribed number of source wiring lines 232 (may also be referred to as “data signal lines”, “source bus lines”, and the like), a prescribed number of gate wiring lines 231 (may also be referred to as “gate signal lines”, “gate bus lines”, and the like), a prescribed number of drain wiring lines 233, and a prescribed plurality of auxiliary capacitance wiring lines 234 (may also be referred to as “holding capacitance wiring lines”, “storage capacitance wiring lines”, “Cs bus lines” and the like) are formed.

The source wiring lines 232 are electrically connected to source electrodes 222 of the plurality of prescribed thin film transistors 22. As shown in FIG. 7 in particular, the prescribed number of source wiring lines 232 are formed so as to be substantially in parallel with each other. The respective source wiring lines 232 can therefore transmit source signals (signals that define luminance gradation of the respective pixels; may also be referred to as “data signals”, “luminance signals”, “gradation signals” and the like) to the source electrodes 222 of the plurality of prescribed thin film transistors 22, respectively.

The gate wiring lines 231 are electrically connected to gate electrodes 221 of the plurality of prescribed thin film transistors 22. As shown in FIG. 7 in particular, a prescribed number of gate wiring lines 231 are formed so as to be substantially in parallel with each other in the direction that is substantially perpendicular to the source wiring lines 232. The respective gate wiring lines 231 can therefore transmit gate pulses (voltage applied to the gate electrode 221 so that a current flows between the source electrode 222 and the drain electrode 223 of the thin film transistor 22; it may also be referred to as “select pulse” and the like) to the gate electrodes 221 of the plurality of prescribed thin film transistors 22, respectively.

The auxiliary capacitance wiring lines 234 and the plurality of prescribed pixel electrodes 26 form auxiliary capacitances (electrically, a type of electrostatic capacitance; may also be referred to as “holding capacitance”, “storage capacitance”, and the like). The auxiliary capacitances are used to maintain the potential of the respective pixel electrodes 26 at a prescribed value for a prescribed period of time so that luminance of the respective pixels is maintained at a prescribed level for a prescribed period of time.

The panel frame region 212 is a region disposed so as to enclose the display region 211. In the panel frame region 212, a sealing pattern region 213 (a region indicated with the hatching) and a terminal region 214 are formed. The sealing pattern region 213 of the second substrate 2 has the substantially same configuration as that of the sealing pattern region 113 of the first substrate 1.

The terminal region 214 is a band-shape region that is formed at the outer edges or near the outer edges of prescribed sides of the panel frame region 212. The second substrate 2 shown in FIG. 6 has a configuration in which the terminal region 214 is formed at outer edges of a pair of two sides that are adjacent to each other (one of the longer sides and one of the shorter sides) of the panel frame region 212. The terminal region 214 is a region to mount a circuit board that includes a source driver (an IC or an LSI that generates source signals based on signals from the outside) that generates source signals based on signals from the outside, and a circuit board that includes a gate driver (an IC or an LSI that generates gate pulses based on signals from the outside) that generates gate pulses based on signals from the outside.

In the panel frame region 212, wiring lines that electrically connect prescribed source wiring lines 232 and prescribed wiring electrode terminals, wiring lines that electrically connect prescribed gate wiring lines 231 and prescribed wiring electrode terminals, wiring lines that electrically connect prescribed auxiliary capacitance wiring lines 234 and prescribed wiring electrode terminals, and other prescribed wiring lines are formed. According to such a configuration, source signals generated by the source driver and gate pulses generated by the gate driver are sent to the source wiring lines 232 and the gate wiring lines 231 formed in the display region 211 through the prescribed wiring lines formed in the panel frame region 212. This makes it possible to apply prescribed voltages to the respective pixel electrodes 26 at prescribed timings.

Next, a method of manufacturing the display panel 3 according to the embodiment of the present invention will be explained. The method of manufacturing the display panel 3 according to the embodiment of the present invention includes a manufacturing process of a color filter (that is, a manufacturing process of the first substrate 1), a manufacturing process of a TFT array substrate (that is, a manufacturing process of the second substrate 2), and a panel manufacturing process (may also be referred to as “cell manufacturing process”).

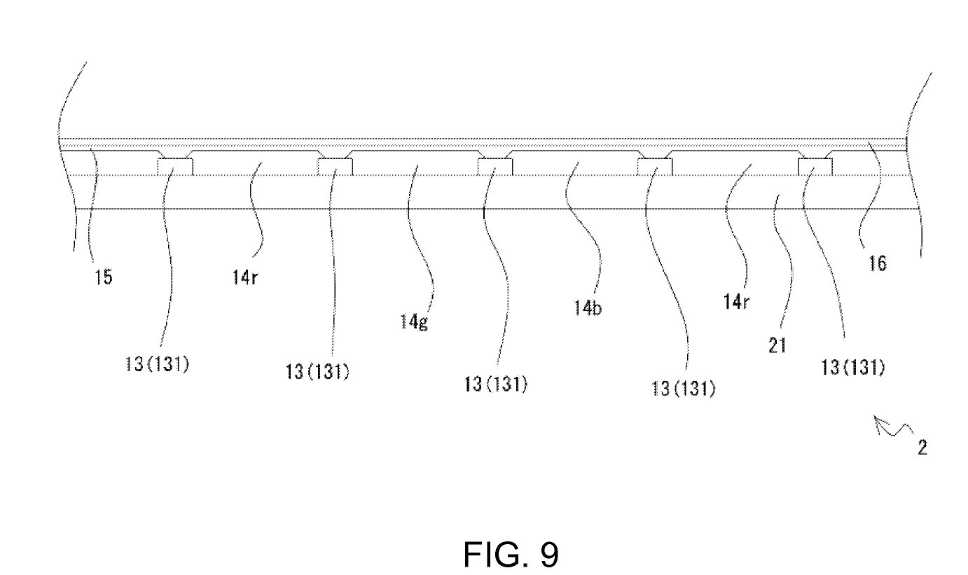

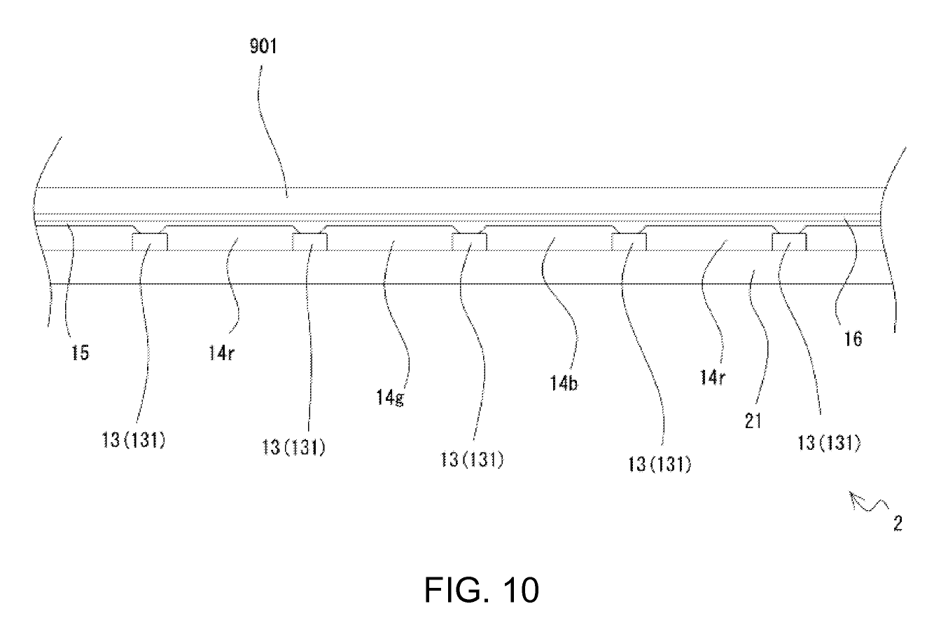

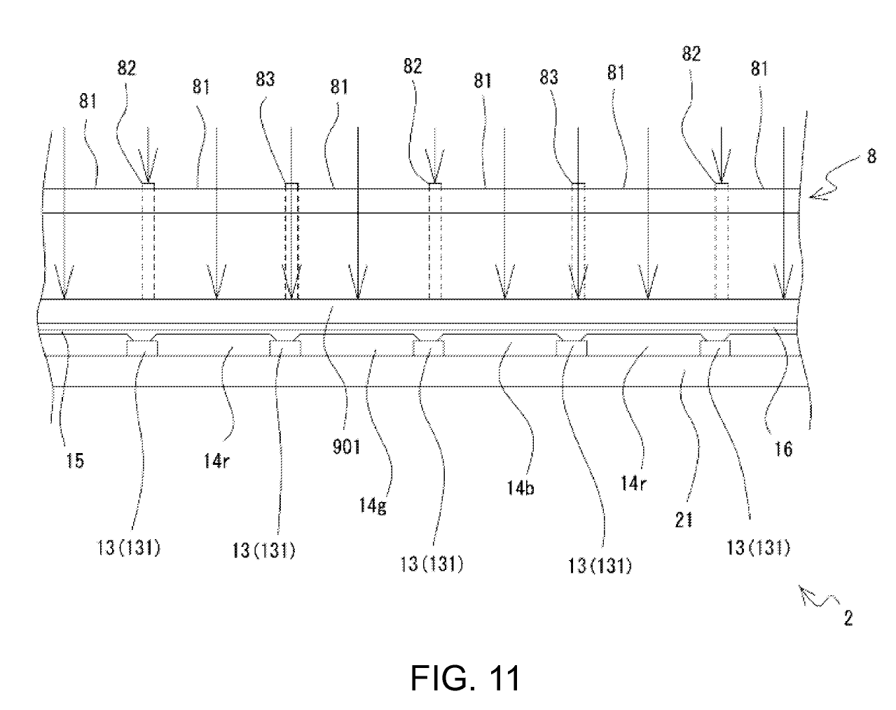

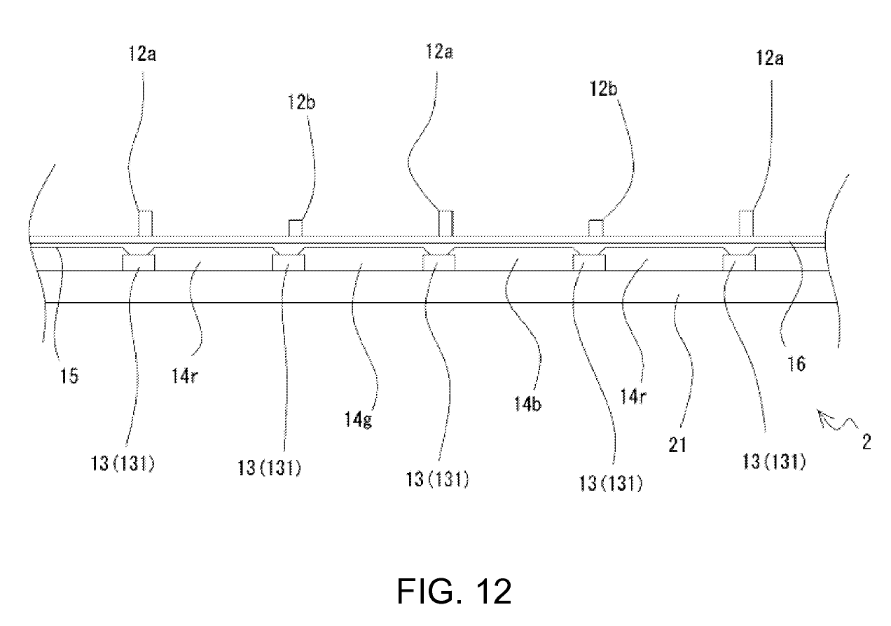

The manufacturing process of a color filter (a manufacturing process of the first substrate 1) will be explained as follows. The manufacturing process of a color filter includes the steps of (1) forming a black matrix, (2) forming colored layers, (3) forming a protective film, (4) forming a common electrode, and (5) forming spacers. FIGS. 9 to 12 are cross-sectional views that schematically show prescribed processes of the manufacturing process of a color filter. Specifically, FIG. 9 is a cross-sectional view that schematically shows the steps of (1) forming a black matrix to (4) forming a common electrode. FIG. 10 is a cross-sectional view that schematically shows a step of forming a photosensitive resin composite film included in the process (5) of forming spacers. FIG. 11 is a cross-sectional view that schematically shows an exposure process included in the process (5) of forming spacers. FIG. 12 is a cross-sectional view that schematically shows a development process included in the process (5) of forming spacers.

In the process (1) of forming a black matrix, as shown in FIG. 9, the black matrix 13 is formed on one surface of the transparent substrate 11 made of glass or the like. The resin BM method, for example, can be employed as the method of forming the black matrix 13 as described below. First, on one surface of the transparent substrate 11, a film is formed of a photosensitive resin composite (hereinafter referred to as “BM resist”) that includes a black colorant. Next, the BM resist film that has been formed is patterned into a prescribed pattern by photolithography. By this patterning, the BM resist film is configured to have openings of a prescribe shape that are arranged in a prescribed manner in the display region 111. In a portion of the panel frame region 112 where light is to be blocked, the BM resist film remains, and the remaining BM resist film becomes a light-shielding film.

In the process (2) of forming colored layers, as shown in FIG. 9, the red colored layers 14r, the green colored layers 14g, and the blue colored layers 14b for color displays are formed. The colored layers 14r, 14g, and 14b of the respective colors can be formed by photolithography, a method employing an inkjet printer, or the like. Specifically, in photolithography, first, on the surface of the transparent substrate 11 where the black matrix 13 has been formed, a film is formed of a photosensitive resin composite that includes a colorant of a prescribed color. Thereafter, by photolithography, an undesired portion is removed from the photosensitive resin material film that has been formed. In this way, a colored layer of a prescribed color is formed in a prescribed opening (light-transmissive region of the pixel) formed in the black matrix 13. The above-mentioned process is conducted for the colored layers of the respective colors: the red colored layers 14r; the green colored layers 14g; and the blue colored layers 14b. In the method employing an inkjet printer, a resin composite that includes a colorant of a prescribed color is injected in a prescribed opening formed in the black matrix 13 by the inkjet printer. Thereafter, the injected resin composite is solidified. In this way, the colored layers of the respective colors 14r, 14g, and 14b are formed.

In the process (4) of forming a protective film, the protective film 15 is formed on one surface (that is, the surface of the black matrix 13, and the surfaces of the colored layers of the respective colors 14r, 14g, and 14b) of the transparent substrate 11 that has undergone the above-mentioned processes. The protective film 15 is formed by using a slit coater, a spin coater, or the like. That is, a solution of a resin composite, which is a material of the protective film 15, is applied (a film made of a solution of a resin composite, which is a material of the protective film 15, is formed) on one surface of the transparent substrate 11 that has undergone the above-mentioned processes. Thereafter, the resin composite solution is solidified. Through this process, the protective film 15 is formed.

In the process (5) of forming a common electrode, the common electrode 16 is formed on a surface of the protective film 15. The common electrode 16 can be formed by a masking method or photolithography. Specifically, when the masking method is employed, a mask that has an opening of a prescribed dimension and shape is placed on the surface of the transparent substrate 11 that has undergone the above-mentioned processes, and then, a transparent conductive material, which is a material of the common electrode 16, is deposited by sputtering or the like. Through this process, the common electrode 16 having a prescribed pattern is formed in a prescribed region on the surface of the transparent substrate 11 (a region corresponding to the opening of the mask). When photolithography is employed, a transparent conductive material film is formed on the surface of the transparent substrate 11 that has undergone the above-mentioned processes, and the conductive material film that has been formed is patterned into a prescribed pattern (that is, a pattern of the common electrode 16) by etching. This results in the common electrode 16 having a prescribed pattern. The conductive material film can be etched by wet etching utilizing ferric chloride, for example. As the transparent conductive material, Indium Tin Oxide is used.

In the process (3) of forming spacers, the first spacers 12a and the second spacers 12b are formed on the surface of the common electrode 16 in the locations that overlap the spacer forming regions 131 of the black matrix 13. The first spacers 12a and the second spacers 12b are made of a photosensitive resin composite, and are simultaneously formed in the same process by photolithography. The details of the process are as follows.

First, as shown in FIG. 10, a film made of a photosensitive resin composite is formed on one surface of the transparent substrate 11, where the common electrode 16 is formed. The photosensitive resin composite film is formed by a method of applying a photosensitive resin composite solution using a slit coater (forming a film of the solution), and thereafter solidifying the applied photosensitive resin composite, for example. The photosensitive resin composite may be of positive-type, or negative-type. Here, a configuration using a positive-type photosensitive resin composite will be explained first.

After the photosensitive resin composite film 901 is formed, as shown in FIG. 11, an exposure process is conducted by using an exposure apparatus (not shown) and a prescribed photomask 8. The arrows in FIG. 11 schematically show light energy delivered by the exposure apparatus. In the prescribed photomask 8, light-transmissive patterns 81, light-shielding patterns 82, and semi-light-transmissive patterns 83 are formed in prescribed shapes. The light-transmissive patterns 81 can transmit the light energy delivered by the exposure apparatus directly or almost directly. The light-shielding patterns 82 block the light energy delivered by the exposure apparatus. The semi-light-transmissive patterns 83 can transmit a reduced amount of the light energy delivered by the exposure apparatus. That is, the intensity of the light energy that has passed through the semi-light-transmissive patterns 83 is lower than the intensity of the light energy that has passed through the light-transmissive patterns 81.

The light-shielding patterns 82 are used to form the first spacers 12a. The light-shielding patterns 82 have a shape corresponding to a cross-sectional shape of the first spacers 12a (a shape that is the substantially same as a cross-sectional shape of the first spacers 12a, for example), and are formed so as to correspond to the locations where the first spacers 12a are to be formed. The semi-light-transmissive patterns 83 are used to form the second spacers 12b. The semi-light-transmissive patterns 83 have a shape corresponding to a cross-sectional shape of the second spacers 12b (a shape that is the substantially same as a cross-sectional shape of the second spacers 12b, for example), and are formed so as to correspond to the locations where the second spacers 12b are to be formed. Regions that are not included in the light-shielding patterns 82 or the semi-light-transmissive patterns 83 become the light-transmissive patterns 81.

As shown in FIG. 11, in the exposure process, portions of the photosensitive resin composite film 901 that become the first spacers 12a are blocked by the light-shielding patterns 82 of the photomask 8, and are not irradiated with the light energy. Portions that become the second spacers 12b are irradiated with the light energy that has been reduced by the semi-light-transmissive patterns 83 (having a lower intensity than that of the light radiated through the light-transmissive patterns 81). The other portions are irradiated with the light energy through the light-transmissive patterns 81.

The irradiation with the light energy renders the positive-type photosensitive resin composite soluble to a developer. The extent of solubility to the developer changes in accordance with the intensity of the radiated light energy. That is, as the intensity of the radiated light energy is increased, the extent of the solubility to the developer becomes higher (more likely to dissolve), and as the intensity of the radiated light energy is decreased, the extent of the solubility to the developer becomes lower (less likely to dissolve). Thus, in the photosensitive resin composite film 901, the portions irradiated with the light energy through the semi-light-transmissive patterns 83 of the photomask 8 becomes less soluble to the developer as compared with the portions irradiated with the light energy through the light-transmissive patterns 81.

Thereafter, the photosensitive resin composite film 901 that has undergone the exposure process is developed. When the development process is conducted, as shown in FIG. 12, the portions irradiated with the light energy through the light-transmissive patterns 81 of the photomask 8 are removed. The portions where the light was blocked by the light-shielding patterns 82 of the photomask 8 remain on the surface of the common electrode 16. These remaining portions become the first spacers 12a. The portions irradiated with the light energy through the semi-light-transmissive patterns 83 are less soluble to the developer as compared with the portions irradiated with the light energy through the light-transmissive patterns 81, and therefore, they are not completely dissolved to the developer, and remain on the surface of the common electrode 16. These remaining portions become the second spacers 12b. However, because the portions irradiated with the light energy through the semi-light-transmissive patterns 83 has solubility to some extent, the thickness thereof is reduced as compared with the portions where the light was blocked by the light-shielding patterns 82. As a result, the second spacers 12b that are shorter than the first spacers 12a can be formed.

A height difference between the first spacers 12a and the second spacers 12b can be set to the above-mentioned range by suitably setting the intensity of the light energy radiated to the photosensitive resin composite.

Even with a negative-type photosensitive resin composite, the first spacers 12a and the second spacers 12b can still be simultaneously formed in the same process. In case of a negative-type photosensitive resin composite, a photomask used in the exposure process has a configuration in which the light-transmissive patterns and the light-shielding patterns are replaced with each other as compared with the photomask 8 that is used in case of the positive-type photosensitive resin composite, while the semi-light-transmissive patterns used to form the second spacers 12b have the same pattern in both cases.

That is, to explain with reference to FIG. 11, the light-shielding patterns 82 of the photomask 8 shown in FIG. 11 become the light-transmissive patterns in the photomask used for the negative-type photosensitive resin composite. The light-transmissive patterns 81 of the photomask 8 shown in FIG. 11 become the light-shielding patterns in the photomask used for the negative-type photosensitive resin composite. The semi-light-transmissive patterns used to form the second spacers 12b have the same pattern whether the photosensitive resin composite is of positive-type or negative-type, but the light energy transmittance level of the semi-light-transmissive patterns (reduction rate of the light energy intensity) is suitably set in accordance with a type of the photosensitive resin composite and the like.

In the exposure process, portions of the film made of the negative-type photosensitive resin composite that become neither the first spacers 12a nor the second spacers 12b are blocked by the light-shielding patterns of the photomask, and are not irradiated with the light energy. Portions that become the first spacers 12a are irradiated with the light energy through the light-transmissive patterns. Portions that become the second spacers 12b are irradiated with the light energy having the intensity that has been reduced by the semi-light-transmissive patterns (having a lower intensity than that of the light energy radiated through the light-transmissive patterns).

Thereafter, the development process is conducted for the negative-type photosensitive resin composite film that has undergone the exposure process. When the development process is conducted, as shown in FIG. 12, the portions of the negative-type photosensitive resin composite that have been irradiated with the light energy through the light-transmissive patterns of the photomask remain on the surface of the common electrode 16 because the solubility thereof to a developer has been lost. The remaining portions become the first spacers 12a. The portions where the light was blocked by the light-shielding patterns of the photomask are soluble to the developer, and are therefore removed. The portions of the negative-type photosensitive resin composite that have been irradiated with the light energy through the semi-light-transmissive patterns are less soluble to the developer, and therefore remain on the surface of the common electrode 16. The remaining portions become the second spacers 12b. Because the portions irradiated with the light energy through the semi-light-transmissive patterns has solubility to some extent, the film thickness thereof is reduced. As a result, the second spacers 12b that are shorter than the first spacers 12a are formed.

As described above, even when a negative-type photosensitive resin composite is used, the first spacers 12a and the second spacers 12b that are shorter than the first spacers 12a can be formed simultaneously in the same process.

The first substrate 1 is manufactured through the above-mentioned processes.

Next, a manufacturing process of a TFT array substrate (a manufacturing process of the second substrate 2 of the display panel 3 according to the embodiment of the present invention) will be explained with reference to FIGS. 6 to 8. As the second substrate 2, a known TFT array substrate can be used, and as the manufacturing method of the TFT array substrate as well, a known manufacturing method of a TFT array substrate can be employed. Therefore, it will be only briefly explained.

First, on one surface of the transparent substrate 21 made of glass or the like (also referred to as a mother glass, a mother substrate, or the like), a single-layer or multiple-layer of conductive film (hereinafter referred to as “first conductive film”) made of chrome, tungsten, molybdenum, aluminum, and the like is formed. As a method of forming the first conductive film, various known sputtering method or the like can be employed. There is no special limitation on the thickness of the first conductive film, but the film can be formed in the thickness of about 300 nm, for example.

The first conductive film that has been formed is thereafter patterned into a prescribed pattern, and becomes the gate wiring lines 231, the auxiliary capacitance wiring lines 234, the gate electrodes 221 of the thin film transistors 22, and the like in the display region 211. In the panel frame region 212, the film becomes the wiring electrode terminals and other prescribed wiring lines. In patterning the first conductive film, various known wet etching methods or the like can be employed. When the first conductive film is made of chrome, for example, wet etching with an (NH₄)₂[Ce(NH₃)₆]+HNO₃+H₂O solution can be employed.

Next, on the surface of the transparent substrate 21 that has undergone the above-mentioned process, an insulating film (hereinafter referred to as “first insulating film 241”) is formed. As the first insulating film 241, a film made of SiNₓ (silicon nitride) or the like in the thickness of about 300 nm can be used. The first insulating film 241 can be formed by the plasma CVD method or the like. When the first insulating film 241 is formed, the gate wiring lines 231, the auxiliary capacitance wiring lines 234, the gate electrodes 221 of the thin film transistors 22, the wiring electrode terminals, and the prescribed wiring lines are covered by the first insulating film 241. A portion of the insulating film that is disposed on the surface of the gate electrode 221 of the thin film transistor 22 becomes a gate insulating film of the thin film transistor 22.

Next, in prescribed positions on the surface of the first insulating film 241, semiconductor films 25 having prescribed dimension and shape are formed. Specifically, the semiconductor films 25 are formed in the position that overlaps the gate electrode 221 of the thin film transistor 22 through the first insulating film 241, and in the position that overlaps the auxiliary capacitance wiring line 234 through the first insulating film 241 where the auxiliary capacitance is to be formed. The semiconductor film 25 has a two-layer structure constituted of a first sub-semiconductor film 251 and a second sub-semiconductor film 252. The first sub-semiconductor film 251 can be formed of amorphous silicon or the like in the thickness of about 100 nm. The second sub-semiconductor film 252 can be formed of n⁺-type amorphous silicon or the like in the thickness of about 20 nm. The first sub-semiconductor film 251 also functions as an etching stopper layer in the step of forming source wiring lines and drain wiring lines by etching or the like. The second sub-semiconductor film 252 has a function of ensuring suitable ohmic contact to the source electrode 222 and the drain electrode 223 of the thin film transistor 22 that are to be formed in the steps described below.

The semiconductor film 25 (the first sub-semiconductor film 251 and the second sub-semiconductor film 252) is formed by employing the plasma CVD method and photolithography. That is, first, a material of the semiconductor film 25 (the first sub-semiconductor film 251 and the second sub-semiconductor film 252) is deposited by the plasma CVD method on one surface of the transparent substrate 21 that has undergone the above-mentioned process. Then, after the semiconductor film 25 (the first sub-semiconductor film 251 and the second sub-semiconductor film 252) is formed, the film is patterned into a prescribed shape by photolithography or the like.

Specifically, on a surface of the semiconductor film 25 that has been formed, a layer of a photoresist material is formed. The photoresist material layer can be formed by a method using a slit coater, a spin coater, or the like. Next, the photoresist material layer that has been formed undergoes an exposure process using a prescribed photomask, followed by a development process. As a result, the prescribed pattern of the photoresist material layer is left on the surface of the semiconductor film 25 in the display region 211. The semiconductor film 25 is then patterned using the patterned photoresist material layer as a mask. For this patterning, wet etching with an HF+HNO₃ solution or dry etching with a Cl₂/SF₆ gas can be employed, for example. In the manner described above, the semiconductor films 25 (the first sub-semiconductor film 251 and the second sub-semiconductor film 252) are formed so as to overlap the gate electrode 221 and the auxiliary capacitance wiring line 234 through the first insulating film 241, respectively.

Next, the source wiring line 232, the drain wiring line 233, and the source electrode 222 and the drain electrode 223 of the thin film transistor 22 will be formed.

First, on one surface of the transparent substrate 21 that has undergone the above-mentioned process, a conductive film (this conductive film is “referred to as a second conductive film”) is formed. The second conductive film is a material for the source wiring line 232, the drain wiring line 233, and the source electrode 222 and the drain electrode 223 of the thin film transistor 22. Thereafter, the second conductive film that has been formed is patterned into a prescribed shape. The second conductive film has a laminated structure constituted of two or more layers that are made of titanium, aluminum, chrome, molybdenum, and the like, for example. When the second conductive film has a two-layer structure including a first sub-conductive film and a second sub-conductive film, for example, the first sub-conductive film can be made of titanium or the like, and the second sub-conductive film can be made of aluminum or the like.

The second conductive film can be formed by sputtering or the like. The patterning of the second conductive film can be conducted by dry etching with a Cl₂/BCl₃ gas, or wet etching with phosphoric acid, acetic acid, and nitric acid. By this patterning, the source wiring line 232, the drain wiring line 233, and the source electrode 222 and the drain electrode 223 of the thin film transistor 22 are formed of the second conductive film. Also, in this patterning, the second sub-semiconductor film is etched by using the first sub-semiconductor film as the etching stopper layer.

Through the above-mentioned processes, the thin film transistors 22 (that is, the gate electrodes 221, the source electrodes 222, the drain electrodes 223, and the gate insulating films), the source wiring lines 232, the gate wiring lines 231, the drain wiring lines 233, and the auxiliary capacitance wiring lines 234 are formed in the display region 211 of the transparent substrate 21.

Next, in the display region 211 of the transparent substrate 21 that has undergone the above-mentioned processes, a second insulating film 242 (also referred to as “passivation film”) and a third insulating film 243 (also referred to as “organic insulating film” or “planarizing film” are formed. This second insulating film 242 can be formed of SiN_{X} (silicon nitride) in the thickness of about 300 nm thick. As a method of forming the second insulating film 242, the plasma CVD method or the like can be employed. On the surface of the second insulating film 242 that has been formed, the third insulating film 243 is formed. The third insulating film 243 can be made of an acrylic resin material. The third insulating film 243 can be formed by a method of applying a solution of the material of the third insulating film 243 by using a slit coater, a spin coater, or the like, and by solidifying the solution thereafter.

The third insulating film 243 that has been formed is patterned into a prescribed pattern by photolithography or the like. By this patterning, an opening for electrically connecting the pixel electrode 26 and the drain wiring line 233 (that is, a contact hole) is formed in the third insulating film 243.

When the opening is formed in the third insulating film 243, a prescribed portion of the second insulating film 242 is exposed through the opening. Thereafter, by using the patterned third insulating film 243 as a mask, the second insulating film 242 is patterned. In this patterning, the portion of the second insulating film 242 that has been exposed through the opening in the third insulating film 243 is removed, resulting in an opening formed in the second insulating film 242. Dry etching with a CF₄+O₂ gas or an SF₆+O₂ gas can be employed for conducting the patterning of the second insulating film 242 and the third insulating film 243.

Next, the pixel electrodes 26 are formed in the display region 211. In the same step, conductors that electrically connect prescribed source wiring lines 232 and prescribed wiring lines (wiring lines that electrically connect prescribed source wiring lines 232 and prescribed wiring electrode terminals, respectively) are formed in the panel frame region 212. The pixel electrodes 26 and the conductors can be made of ITO (Indium Tin Oxide) in the thickness of about 100 nm, for example. As a method of forming the pixel electrodes 26 and the conductors, various known sputtering methods can be used.

Through the above-mentioned processes, the second substrate 2 (TFT array substrate) of the display panel 3 according to the embodiment of the present invention is manufactured.

Next, a panel manufacturing process (cell manufacturing process) will be explained. The details of the panel manufacturing process are as follows. First, on the respective surfaces of the first substrate 1 (color filter) and the second substrate 2 (TFT array substrate) that have been obtained through the above-described processes, alignment films are formed. Thereafter, the first substrate 1 and the second substrate 2 are bonded together, and liquid crystals are filled between these substrates.

A method of forming alignment films 35 and 36 is as follows. First, on the respective surfaces of the first substrate 1 and the second substrate 2, an alignment material is applied. The “alignment material” is a solution including a substance that is a material of the alignment films 35 and 36. As the material of the alignment films 35 and 36, polyimide is used, for example. The applied alignment material is heated and baked by an alignment film baking apparatus or the like. The alignment films 35 and 36 are formed through the above-mentioned process. The first substrate 1 and the second substrate 2 may also be configured without the alignment films 35 and 36 because the orientation of the liquid crystals is defined by the polymer network. When the substrates are configured without the alignment films 35 and 36, the process of forming the alignment films 35 and 36 as well as the need for the alignment material can be eliminated.

Next, the sealing material 34 is applied on the sealing pattern region 113 of the first substrate 1 or the sealing pattern region 213 of the second substrate 2 by using a seal patterning apparatus or the like. As the sealing material 34, various known photosetting resin composites or thermosetting resin composites can be used.

Next, by using a liquid crystal dropping apparatus or the like, liquid crystals including monomers (acrylic monomers, for example) are dropped in a region enclosed by the sealing material 34 (a region inside of the sealing pattern region 113 or 213).

Next, under an atmosphere of a reduced pressure, the first substrate 1 and the second substrate 2 are assembled. When the first substrate 1 and the second substrate 2 are assembled, the sealing pattern region 113 of the panel frame region 112 formed in the first substrate 1 and the sealing pattern region 213 of the panel frame region 212 formed in the second substrate 2 face each other with a prescribed very small gap therebetween. The layer of the sealing material 34 is formed so as to fill the gap between the two. The display region 111 formed in the first substrate 1 and the display region 211 formed in the second substrate 2 also face each other with a prescribed very small gap therebetween. The layer of the polymer network liquid crystals 33 is formed therebetween.

Thereafter, the sealing material 34 is solidified. If the sealing material 34 is a photosetting resin composite, the sealing material 34 is irradiated with light energy (ultraviolet light, for example) having a prescribed wavelength band. If made of a thermosetting resin composite, the sealing material 34 is heated to a prescribed temperature. When the sealing material 34 is cured, the layer of the sealing material 34 in a solid state is formed between the first substrate 1 and the second substrate 2. The first substrate 1 and the second substrate 2 are therefore bonded to each other, and the liquid crystals including monomers are sealed in the region enclosed by the layer of the sealing material 34.

Further, light energy (ultraviolet light, for example) having a prescribed wavelength band is radiated to the polymer network liquid crystals 33 that are sealed between the first substrate 1 and the second substrate 2. When irradiated with the light energy, the monomers included in the polymer network liquid crystals 33 are polymerized and become polymers, and therefore, a polymer microphase-separated structure (polymer network) is formed between the first substrate 1 and the second substrate 2.

Thereafter, on the respective outer surfaces of the first substrate 1 and the second substrate 2, polarizing films (not shown) are bonded. As the polarizing films, known polarizing films can be employed, and therefore, they will not be explained here.

The display panel 3 of the present embodiment is manufactured through the above-mentioned processes.

### INDUSTRIAL APPLICABILITY

The embodiments of the present invention have been described above. However, the present invention is not limited to the above-mentioned embodiments, and it is apparent that various modifications can be made without departing from the spirit of the present invention.

Although a transmissive liquid crystal display panel has been described in the above-mentioned embodiments, the present invention can also be used in a reflective liquid crystal display panel or a transflective liquid crystal display panel, for example.

1. A display panel, comprising:
two substrates that face each other in a substantially parallel manner with a prescribed gap therebetween;
a layer of a liquid crystal formed between said two substrates; and
a layer of a sealing material that encloses and seals said liquid crystal;
wherein said liquid crystal layer is a layer made of a polymer network liquid crystal,
wherein at least one of said two substrates has first spacers that define the gap between said two substrates in a region enclosed by said sealing material, and
wherein a total cross-sectional area of said first spacers and an area of the region enclosed by the sealing material are set so as to satisfy the following condition: (the total cross-sectional area of the first spacers)/(the area of the region enclosed by the sealing material)=0.001 to 0.017.

2. The display panel according to claim 1, wherein said first spacer has a columnar structure.

3. The display panel according to claim 1, wherein one of said two substrates is a color filter including a colored layer, and the other of said two substrates is a TFT array substrate including a pixel electrode and a thin film transistor that drives the pixel electrode, and
wherein said first spacer is formed in said color filter.

4. The display panel according to claim 1, wherein a second spacer that is shorter than said first spacer is formed in one of said two substrates.

5. The display panel according to claim 4, wherein a height difference between said first spacer and said second spacer is in a range of 0.1 to 1.0 μm.

6. The display panel according to claim 4, wherein one of said two substrates is a color filter including a colored layer, and the other of said two substrates is a TFT array substrate including a pixel electrode and a thin film transistor that drives the pixel electrode, and
wherein said second spacer is formed in said color filter.

7. The display panel according to claim 6, wherein said first spacer and said second spacer are made of a same material.
